(19) United States
(12) Patent Application Publication
(10) Pub. No.: US 2024/0194959 A1
(43) Pub. Date: Jun. 13, 2024

(54) BATTERY CELL INCLUDING POP-UP PRESSURE INDICATOR AND BATTERY DEVICE INCLUDING THE SAME

(71) Applicant: SK On Co., Ltd., Seoul (KR)

(72) Inventors: John Cronin, Jericho, VT (US); Na Hyun SHIN, Daejeon (KR); Soo Min PARK, Daejeon (KR); Hyung Ju PAIK, Daejeon (KR); Hae Ryong JEON, Daejeon (KR)

(21) Appl. No.: 18/360,818

(22) Filed: Jul. 28, 2023

Related U.S. Application Data
(60) Provisional application No. 63/430,834, filed on Dec. 7, 2022.

(51) Int. Cl. H01M 10/48; H01M 50/103; H01M 50/15; H01M 50/209; H01M 50/342

(52) U.S. Cl. CPC H01M 10/488; H01M 50/103; H01M 50/15; H01M 50/209; H01M 50/3425; H01M 2200/20

(57) ABSTRACT

A battery cell includes a case configured to accommodate an electrode assembly; a cap plate covering the case; and a pop-up pressure indicator including a pop-up indicator configured to protrude outwardly when pressure in the case increases.

### CROSS-REFERENCE TO RELATED APPLICATION (S)

This patent document claims the benefit of U.S. Provisional Patent Application No. 63/430,834 filed on Dec. 7, 2022, the disclosure of which is incorporated herein by reference in its entirety.

### TECHNICAL FIELD

The technology and implementations disclosed in this patent document generally relate to a secondary battery cell which may be charged and discharged and a battery device including the same, more particularly, a battery cell having improved stability and a battery device including the same.

### BACKGROUND

Battery cells may have issues with a temperature/and pressure increase when excessive heat and pressure builds up in a can (case) thereof. An increase in pressure of a battery cell may compromise the functional safety and reliability of prismatic battery cells.

In addition, when various events occur, such as when a battery cell reaches the end of a lifespan thereof, when a swelling phenomenon occurs in a battery cell, when an overcharge occurs in a battery cell, when a battery cell is exposed to heat, when a sharp object such as a nail penetrates the case of a battery cell, and when an external shock is applied to a battery cell, temperature and/or pressure of the battery cell may increase, and a fire may accordingly occur. A flame or high-temperature gas ejected from a battery cell may cause chain ignition of other, adjacent battery cells accommodated in a battery device.

### SUMMARY

When a battery cell is installed in a battery device (for example, a battery module, a battery pack, an energy storage device, or the like), the entirety of battery cells of the battery device may need to be replaced because the battery cell in which an error occurred may not be identified.

To detect a battery cell in which an event such as a pressure rise has occurred in a battery device or to monitor battery cells, a test device such as a pressure measuring device may need to be used.

According to an aspect of the present disclosures, a battery cell which may easily monitor abnormal conditions of a battery cell by visually checking pressure of a battery cell without using an additional measurement device (for example, a pressure measuring device), and a battery device including the same may be provided. Also, a battery cell which may reduce costs consumed in a battery cell test process and/or inspection process and a battery device including the same may be provided.

According to an aspect of the present disclosures, a battery cell which may easily recognize a battery cell with increased pressure when internal pressure of a portion of battery cells among a plurality of battery cells increases, and a battery device including the same may be provided.

A battery cell in the present disclosure may be widely applied in green technology fields such as electric vehicles, battery charging stations, solar power generation using other batteries, and wind power generation. Also, the battery cell in the present disclosure may be used in eco-friendly electric vehicles, hybrid vehicles, and the like to prevent climate change by suppressing air pollution and greenhouse gas emission.

In some embodiments of the disclosed technology, a battery cell includes a case configured to accommodate an electrode assembly; a cap plate covering the case; and a pop-up pressure indicator including a pop-up indicator configured to protrude outwardly when pressure in the case increases.

According to an embodiment, the pop-up pressure indicator further includes a housing accommodating at least a portion of the pop-up indicator, and the pop-up indicator penetrates through the housing and is exposed externally.

According to one embodiment, the pop-up indicator may be configured such that a length protruding externally of the housing is changed depending on changes in pressure in the case.

According to one embodiment, the pop-up indicator may be partitioned into a plurality of regions depending on a length protruding externally of the housing.

According to one embodiment, the plurality of regions may be configured to be visually distinct.

According to one embodiment, the housing may be fixed to the cap plate or the case.

According to one embodiment, the housing may be screwed or welded to the cap plate or the case.

According to one embodiment, the cap plate may include a coupling hole communicating with an internal space of the case, and the housing is installed in the coupling hole.

According to one embodiment, the housing may be fixed to the coupling hole on an external side of the cap plate.

According to one embodiment, a first side of the housing may be fixed to the coupling hole, and a second side of the housing may be disposed between the case and the electrode assembly.

According to one embodiment, a width of a portion of the housing opposing the case may have a value greater than a thickness of a portion of the housing disposed between the case and the electrode assembly.

According to one embodiment, the housing may include a first side fixed to the coupling hole, and a second side disposed between the cap plate and the electrode assembly.

According to one embodiment, the housing may include a first body fixed to the coupling hole and a second body connected to the first body and inclined with respect to the first body, and the second body may be disposed between the cap plate and the electrode assembly.

According to one embodiment, the first body and the second body may be connected to each other by a guide surface including a curved surface, and the pop-up indicator may include a bendable material to smoothly move through the guide surface between an inner space of the first body and an inner space of the second body.

According to one embodiment, the pop-up pressure indicator may further include a pressure transmission part coupled to the pop-up indicator and transmitting pressure in the case to the pop-up indicator.

According to one embodiment, the pressure transmission part may include a deformation part configured to deform depending on changes in pressure in the case and configured to move the pop-up indicator, and the deformation part may be fixed to each of the housing and the pop-up indicator.

According to one embodiment, the pressure transmission part may include a moveable part fixed to the pop-up indicator and configured to move in the housing depending on changes in pressure in the case, and the moveable part may be configured to slide in the housing.

According to one embodiment, the housing may further include a stopper configured for limiting movement of the pressure transmission part.

According to one embodiment, the pressure transmission part may include a burstable slide part configured to be broken when in contact with the stopper.

According to one embodiment, the pressure transmission part may be configured to be broken when pressure in the case at a set pressure or higher, and gas in the case is discharged externally through the housing by the breakage of the pressure transmission part.

In some embodiments of the disclosed technology, a battery device includes a plurality of battery cells; and a device housing configured to accommodate the plurality of battery cells, wherein at least one battery cell of the plurality of battery cells includes a case configured to accommodate an electrode assembly, a cap plate covering the case, and a pop-up indicator protruding outwardly when pressure in the case increases.

According to one embodiment, an abnormal situation of a battery cell may be easily monitored by visually checking pressure of the battery cell without using an additional measurement device (for example, a pressure measuring device).

According to one embodiment, costs consumed in a battery cell test process and/or inspection process may be reduced.

According to one embodiment, when internal pressure of a portion of battery cells among a plurality of battery cells increases, a battery cell with increased pressure may be easily recognized. Accordingly, convenience of replacing a battery cell in which an abnormal situation has occurred may improve.

### BRIEF DESCRIPTION OF DRAWINGS

Certain aspects, features, and advantages of the disclosed technology are illustrated by the following detailed description with reference to the accompanying drawings.

FIG. 1 is an exploded perspective view of a battery cell according to one embodiment.

FIGS. 2A, 2B, and 2C are views for illustrating a top cap assembly according to one embodiment.

FIGS. 3A to 3F are a view for illustrating an assembly process of a top cap assembly and an electrode assembly according to one embodiment.

FIGS. 4A to 4F are a view for illustrating an assembly process of an electrode assembly, a jelly roll bag, and a can according to one embodiment.

FIG. 5A is a perspective view of an electrode assembly including an electrode foil, according to one embodiment.

FIG. 5B is a perspective view illustrating a connection between an electrode foil and an electrode terminal on a top cap assembly, according to one embodiment.

FIGS. 6A to 6D are views illustrating a vent cover according to an embodiment. FIG. 6A is a cross-sectional perspective views illustrating a portion of the vent cover illustrating in FIG. 2A. FIG. 6B is a cross-sectional view illustrating a state before a vent cover is deformed. FIG. 6C is a cross-sectional view illustrating a state in which the vent cover is expanded or inflated, and FIG. 6D is a state in which the vent cover is broken.

FIGS. 7A, 7B, and 7C are views illustrating a modified example of a vent cover. FIG. 7A is a cross-sectional view illustrating a first modified example of a vent cover, FIG. 7B is a cross-sectional view illustrating a second modified example of a vent cover, and FIG. 7C is a cross-sectional perspective view illustrating a portion of the vent cover illustrated in FIG. 7B.

FIG. 8 is a chart illustrating a relationship between pressure and the number of charging cycles a battery cell has gone through.

FIG. 9A is an exploded perspective view illustrating a battery cell according to an embodiment, FIG. 9B is a perspective view illustrating a top cap assembly illustrated in FIG. 9A viewed from the bottom.

FIG. 10A is a perspective view illustrating the pop-up pressure indicator illustrated in FIG. 9A. FIG. 10B is a view illustrating the pop-up indicator illustrated in FIG. 10A.

FIGS. 11A and 11B are cross-sectional views taken along line I-I′ in FIG. 9A. FIG. 11A illustrates a normal state, and FIG. 11B illustrates a state in which internal pressure rises.

FIGS. 12A and 12B are cross-sectional views illustrating a modified example in FIGS. 11A and 11B. FIG. 12A illustrates a normal state, and FIG. 12B illustrates a state in which internal pressure rises.

FIG. 13 is an exploded perspective view illustrating a battery cell according to another embodiment.

FIG. 14A is a view illustrating the pop-up pressure indicator illustrated in FIG. 13, viewed from the front. FIG. 14B is a cross-sectional view taken along line II-II′ in FIG. 14A. FIG. 14C is a cross-sectional view taken along line III-III′ in FIG. 14A.

FIGS. 15A and 15B are cross-sectional view taken along line IV-IV′ in FIG. 13. FIG. 15A illustrates a normal state, and FIG. 15B illustrates a state in which internal pressure rises.

FIG. 16 is an exploded perspective view illustrating a battery cell according to another embodiment.

FIG. 17A is a cross-sectional view taken along line V-V′ in FIG. 16. FIG. 17B is a cross-sectional view taken along line VI-VI′ in FIG. 17A. FIG. 17C is a cross-sectional view taken along line VII-VII′ in FIG. 17A.

FIG. 18 is a perspective view illustrating a pop-up pressure indicator according to an embodiment.

FIGS. 19A to 19C are cross-sectional views taken along line VIII-VIII′ in FIG. 18. FIG. 19A illustrates a normal state, and FIG. 19B illustrates a state in which internal pressure further rises than in FIG. 19A. FIG. 19C is a state in which internal pressure further rises than in FIG. 19B.

FIG. 20 is a view illustrating a battery device according to an embodiment.

### DETAILED DESCRIPTION

Features of the disclosed technology disclosed in this patent document are described by example embodiments with reference to the accompanying drawings.

Embodiments of the disclosed technology will be more fully described below with reference to the accompanying drawings, and like numbers indicate like elements throughout the several views, and example embodiments are illustrated. However, embodiments of the claims may be implemented in many different forms and are not limited to the embodiments described herein. The examples given herein are non-limiting and only examples among other possible examples.

In the following description, ‘including’ a certain element means that other elements may be further included, rather than excluding other elements unless otherwise stated.

In addition, terms including ordinal numbers such as “first” and “second” used in this specification may be used to describe various components, and the components are not limited by the terms. These terms are only used for the purpose of distinguishing one component from another. For example, a first component may be termed a second component without departing from the scope of the disclosed technology, and similarly, the second element may also be termed the first element.

It should be noted that in the accompanying drawings, like elements are indicated by the same reference numerals as much as possible. In addition, detailed descriptions of well-known functions and configurations that may obscure the gist of the disclosed technology will be omitted. For the same reason, in the accompanying drawings, some components are exaggerated, omitted, or schematically illustrated, and the size of each component does not entirely reflect actual size.

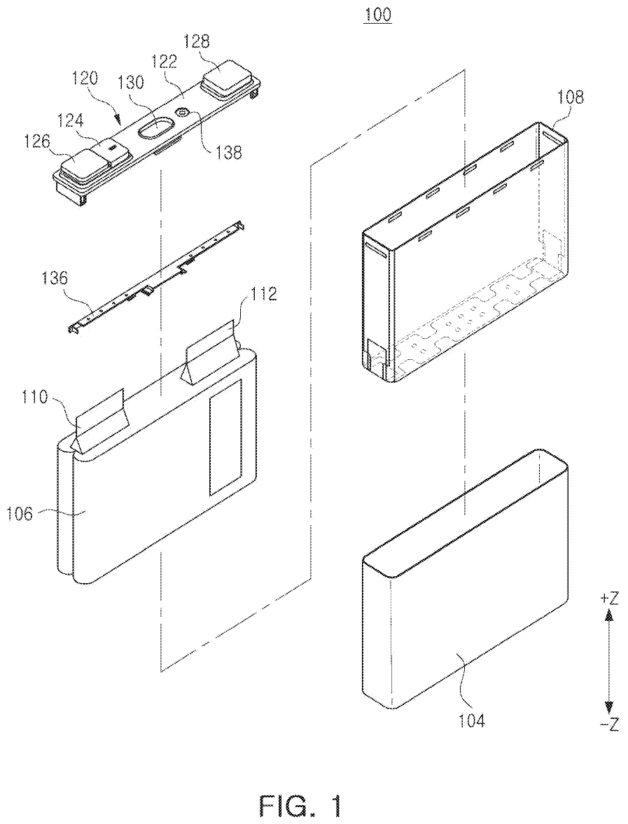

FIG. 1 is an exploded perspective view of a battery cell according to an embodiment.

Referring to FIG. 1, a battery cell 100 may be a prismatic cell. Prismatic cells are widely used in powertrains of electric vehicles. The prismatic cells may be stacked together in a rectangular shape, allowing more efficient use of space. Prismatic cells are generally rectangular and have a higher power density than cylindrical cells. Prismatic cells also provide better performance in cold weather and less damage from vibration. However, prismatic cells may be more expensive to manufacture than cylindrical cells. In addition, prismatic cells are less likely to fail due to vibration or movement. Prismatic cells may deliver more power than cylindrical battery cells due to spatial optimization of the rectangular shape thereof.

The prismatic battery cell 100 includes a rectangular can 104 that may be formed of steel, aluminum, aluminum alloy, plastic, or other metals having sufficient structural strength. The can 104 may be manufactured according to various different methods including deep draw or impact extrusion. The method for manufacturing the can 104 may be combined with wall ironing to achieve the final geometry, thickness and tolerances. The can 104 may be wrapped with cell cover tape.

A jelly roll 106 includes a stacked anode, cathode and separator. A jelly roll 106 type electrode assembly configured to have a structure of a long sheet type cathode and a long sheet type anode to which an active material is applied is wound. At the same time, the stacked-type electrode assembly has a structure in which a separator is disposed between a cathode and an anode or has a structure in which a plurality of cathodes and anodes having a predetermined size are sequentially stacked and a separator is disposed between each of the cathodes and the anode. The jelly roll-type electrode assembly is easy to manufacture and has high unit mass and energy density, compared to a sheet-type electrode assembly. In some batteries, one or more jelly rolls 106 are inserted into can 104. Each jelly roll (electrode assembly) 106 is inserted inside the can 104 while being accommodated in a polymer jelly roll bag 108 or wrapped in a jelly roll sealing tape.

Each jelly roll 106 includes a cathode foil 112 formed of aluminum. The aluminum foil is coated with the electrode slurry. A first operation of electrode manufacturing is a slurry mixing process in which an active raw material is combined with a binder, a solvent and an additive. This mixing process should be performed separately for anode and cathode slurries. Viscosity, density, solids content and other measurable properties of the slurry affect battery quality and electrode uniformity. For example, a slurry having a faster drying rate, a higher solids content, a lower rate capability, and a low viscosity is generated as a solvent content is higher. Thereafter, the cathode slurry is applied to an aluminum foil and dried. A slot die coater is a method of coating a foil in which a slurry is spread through slot gaps on the moving foil receiving tension over rollers. In some embodiments, this may be performed simultaneously on both sides of the foil. This production method enables high speed, while achieving precision in coating thickness. A drying process may be incorporated into a continuous coating. The drying process should achieve three objectives: diffusion of the binder, sedimentation of particles, and evaporation of the solvent. Air floatation is a method of drying the slurry on the foil. Uniformity of the electrode coating and drying process affects the safety, consistency and life cycle of the prismatic battery cell 100. The electrode should go through a calendering process in which electrode porosity and twist are controlled by compressing the coated electrode sheet to a uniform thickness and density.

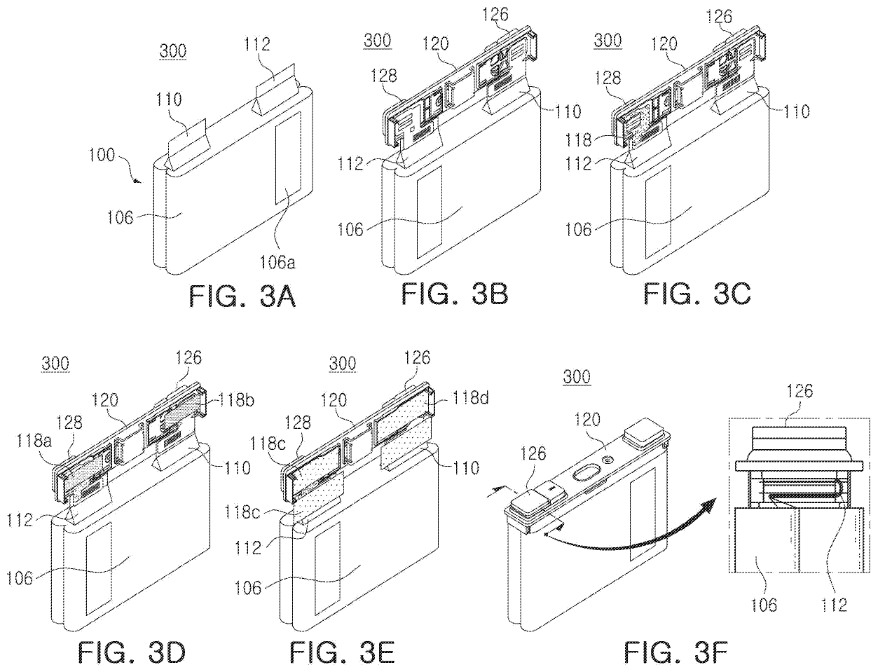

Each jelly roll 106 includes an anode foil 110 formed of copper foil. The anode foil 110 is provided similarly to a cathode foil 112. Each jelly roll 106 may include a cathode connector (not shown) that makes an electrical connection between the inner end portion of the cathode foil 112 and the cathode terminal 128. Each jelly roll 106 may include an anode (not shown) that makes an electrical connection between the inner end portion of the anode foil 110 and an anode terminal 126. Each jelly roll 106 may include a cathode connector mask (e.g., a cathode connector mask 118 in FIG. 3C).

Each prismatic battery cell 100 may have a top cap assembly (upper cap assembly) 120 welded or otherwise bonded to the top of the can 104. The top cap assembly 120 may include a base plate 122 attached to the can 104. The base plate 122 isolates the inside and outside of the cell by welding with the can 104. The base plate 122 may serve as a rigid support structure for elements within the top cap assembly 120. The top cap assembly 120 may include a plurality of top insulators 124 to insulate the base plate 122. The top insulator 124 may prevent leakage of an electrolyte from battery the prismatic cell 100. Additionally, the top insulator 124 may isolate the can 104 from the cathode foil 112 and prevent penetration of moisture and gases from the outside of the cell. A portion of the top insulator 124 may protect a current interrupting device. The top cap assembly 120 includes a cathode terminal 128 electrically connecting the inside and outside of the prismatic battery cell 100. The top cap assembly 120 includes an anode terminal 126 electrically connecting the inside and outside of the prismatic battery cell 100.

The top cap assembly 120 may include a vent cover 130 allowing exhaust gases from the prismatic battery cell 100 to be discharged in a controlled direction and at a controlled pressure. The top cap assembly 120 may include a vent guard 132 protecting the vent cover 130 from the inside of the prismatic battery cell 100 in order to prevent the vent cover 130 from malfunctioning. The top cap assembly 120 may include an overcharge safety device 134 preventing an external current from being introduced using an internal gas pressure of the prismatic battery cell 100. The top insulator 124 may be multi-component. In some embodiments, side portions of the top insulator 124 may be mounted on the edges of the can 104 and the top cap assembly 120. Once the prismatic battery cell 100 is configured, an electrolyte solution may be injected through an electrolyte injection port. An electrolyte cap 138 may close or seal the injection port.

The battery cell 100 may include an insulator 136 located between the top cap assembly 120 and the can 104.

In this document, the electrode assembly of the battery cell 100 is described as the jelly roll 106, but the electrode assembly of the battery cell 100 is not limited to the jelly roll 106. For example, the jelly roll 106 may be replaced with a stack type electrode assembly or a Z-folding type electrode assembly. According to an embodiment, the jelly roll 106 described herein may refer to an electrode assembly.

In this document, the can 104 may be referred to as a case or housing.

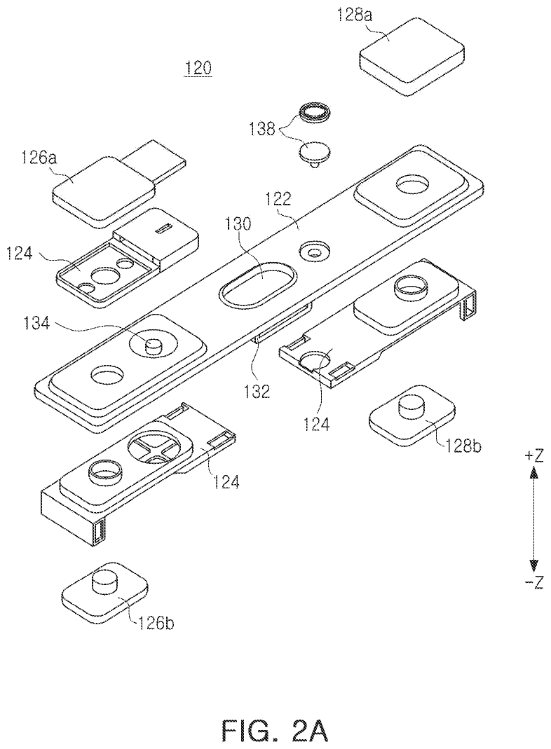

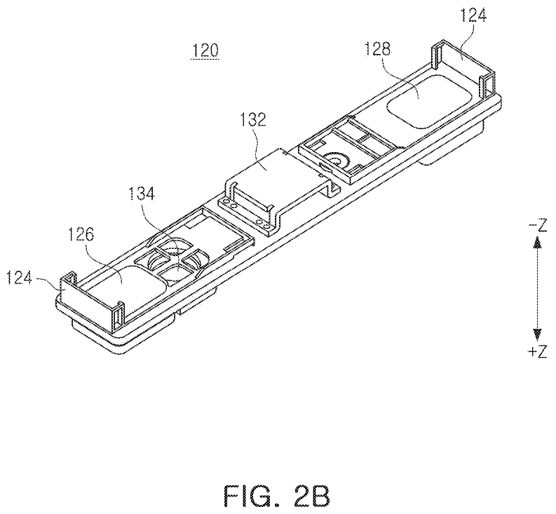

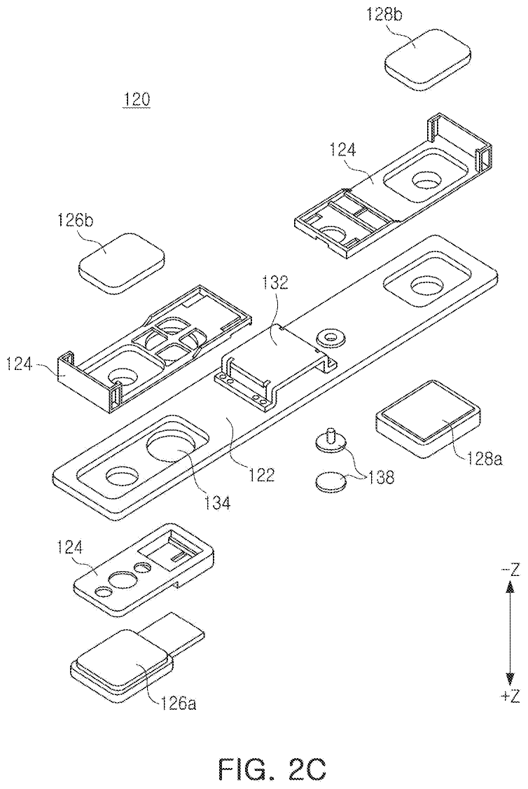

FIGS. 2A, 2B and 2C show a configuration and component functions of the top cap assembly 120. For example, FIG. 2A is an exploded perspective view of the top cap assembly 120 according to an embodiment of the present disclosure. FIG. 2B is a rear perspective view of the top cap assembly 120 according to an embodiment of the present disclosure. Description of the top cap assembly 120 of FIG. 1 may be applied to the top cap assembly 120 of FIGS. 2A, 2B and 2C.

The top cap assembly 120 serving as a cover for the prismatic battery cell 100 is a complex assembly including a plurality of welded components. Adhesives may be used instead of welding specific components.

The prismatic battery cell 100 may include the vent cover 130. The vent cover 130 provides overpressure alleviation when temperature and corresponding pressure increase in the prismatic battery cell 100. For example, the vent cover 130 may be activated in a preset pressure range. The vent cover 130 may be laser-welded to the top cap assembly 120.

The prismatic battery cell 100 may include the can 104. The can 104 may generally be formed of deep-drawn aluminum or stainless steel to prevent moisture from entering the cell, while providing diffusion resistance to organic solvents, such as liquid electrolytes. The most important reason the can 104 is typically formed of deep-drawn aluminum alloy or stainless steel is to reduce a welding point to improve the mechanical strength of the can 104. The electrolyte may be filled in the prismatic battery cell 100 through an injection port. After the electrolyte is filled, the injection port may be closed or sealed by an electrolyte cap 138. After electrolyte filling, the electrolyte cap 138 may be welded to the top cap assembly 120 or a locking ball (not shown) may be forced into the injection port. The cell may have an overcharge safety device 134 that may disconnect current flow when high internal pressure is reached in the prismatic battery cell 100. A rise in pressure is usually a result of high temperatures.

According to an embodiment, the cathode terminal 128 may be provided in plural. For example, the cathode terminal 128 may include a first cathode terminal 128a in which at least a portion is exposed to the outside of the battery cell 100 and a second cathode terminal 128b connected to a cathode foil (e.g., the cathode foil 112 of FIG. 1). The second cathode terminal 128b may be electrically connected to the first cathode terminal 128a. For example, a portion of the second cathode terminal 128b may contact the first cathode terminal 128a.

According to an embodiment, the anode terminal 126 may be provided in plural. For example, the anode terminal 126 may include a first anode terminal 126a in which at least a portion is exposed to the outside of the battery cell 100 and a second anode terminal 126b connected to an anode foil (e.g., the anode foil 110 of FIG. 1). The second anode terminal 126b may be electrically connected to the first anode terminal 126a. For example, a portion of the second anode terminal 126b may contact the first anode terminal 126a.

FIGS. 3A to 3F are a view illustrating an assembly process of a top cap assembly and an electrode assembly according to an embodiment. A battery cell manufacturing process 300 may include an assembly process of the top cap assembly 120 and the jelly roll 106.

Referring to FIG. 3A, a sealing tape 106a may be attached to the jelly roll 106. According to an embodiment, the sealing tape 106a can cover at least a portion of the jelly roll 106. According to an embodiment, the sealing tape 106a may seal a portion of the jelly roll 106.

Referring to FIG. 3B, the jelly roll 106 may be connected to the top cap assembly 120. For example, a connection component for connecting the jelly roll 106 and the top cap assembly 120 may be prepared. The top cap assembly 120 may be closely attached to the jelly roll 106 using the connection component. For example, the cathode terminal 128 of the top cap assembly 120 may be connected to the cathode foil 112 of the jelly roll 106, and the anode terminal 126 of the top cap assembly 120 may be connected to the jelly roll 106. The cathode terminal 128 may be welded to the cathode foil 112 and the anode terminal 126 may be welded (e.g., ultrasonic-welded) to the anode foil 110.

Referring to FIG. 3C, at least a portion of the cathode terminal 128 may be masked. For example, the cathode connector mask 118 may be disposed to cover a portion of the cathode terminal 128. The cathode connector mask 118 may protect the cathode terminal 128. Although not shown, the description of the masking of the cathode terminal 128 may be applied to the anode terminal 126 as well.

Referring to FIG. 3D and/or FIG. 3E, tape may be attached to at least a portion of the cathode terminal 128 and the anode terminal 126. For example, the battery cell 100 may include welding tapes 118a, 118b, 118c, and 118d attached to at least a portion of the cathode terminal 128, the anode terminal 126, the cathode foil 112, and/or the anode foil 110. According to an embodiment, the welding tapes 118a, 118b, 118c, 118d may be attached to at least a portion of a joint portion of the cathode terminal 128, the anode terminal 126, the cathode foil 112, and/or the anode foil 110. As the joint portion is covered with the welding tapes 118a, 118b, 118c, and 118d, the cathode terminal 128 and the anode terminal 126 may be protected.

Referring to FIG. 3F, the anode foil 110 connected to the anode terminal 126 may be folded. For example, when the top cap assembly 120 is disposed on the jelly roll 106, at least a portion of the anode foil 110 may be folded. Although not shown, when the top cap assembly 120 is placed on the jelly roll 106, the cathode foil 112 may also be folded.

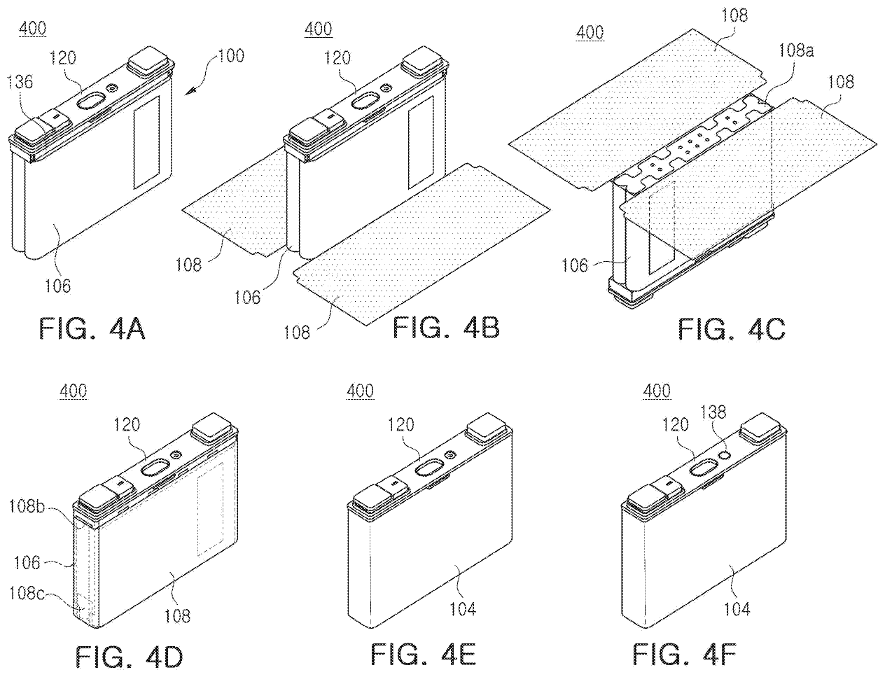

FIGS. 4A to 4F are a view illustrating an assembly process of an electrode assembly, a jelly roll bag, and a can. A battery cell manufacturing process 400 may include an assembly process of the jelly roll 106, the jelly roll bag 108, and the can 104.

Referring to FIG. 4A, an insulator 136 may be installed on the battery cell 100. For example, the insulator 136 may be disposed between the can 104 and the cap assembly 120.

Referring to FIG. 4B, the jelly roll bag 108 may be prepared. The jelly roll bag 108 may cover at least a portion (e.g., a side surface) of the jelly roll 106. The jelly roll 106 may be surrounded by the jelly roll bag 108. The jelly roll bag 108 may protect the jelly roll 106 from external impact. In FIG. 4B, a structure in which the jelly roll bag 108 is disposed on two side surfaces of the jelly roll 106 is shown, but the structure of the jelly roll bag 108 is not limited thereto. For example, according to an embodiment, the jelly roll bag 108 may be formed to cover four side surfaces of the jelly roll 106.

Referring to FIG. 4C, an insulator 108a may be attached to the jelly roll 106. According to an embodiment, in a state in which the jelly roll bag 108 is unfolded, the insulator 108a may be attached to a lower portion of the jelly roll 106. The insulator 108a may be referred to as a lower insulator.

Referring to FIG. 4D, at least some of the components of the battery cell 100 may be taped. For example, the battery cell 100 may include the top cap assembly 120, the can 104, and/or at least one first tape 108b attached onto insulator 136, and/or a second tape 108c attached to a lower portion of the jelly roll bag 108 along a side portion of the insulator 136.

Referring to FIG. 4E, the jelly roll 106 may be inserted into the can 104. The jelly roll 106 and/or the jelly roll bag 108 may be inserted into the can 104.

According to an embodiment, the battery cell manufacturing process 400 may include a wetting process of the jelly roll 106. For example, the jelly roll 106 may be initially wetted by an electrolyte delivered through an electrolyte injection port. For example, partial vacuum may be formed in the prismatic battery cell 100, and a predetermined amount of electrolyte may be injected through the electrolyte injection port. The partial vacuum may improve the distribution and wetting of all layers within the jelly roll 106. Wetting of all layers within the jelly roll 106 may require a rolling or spinning protocol to enhance wetting.

According to an embodiment, the battery cell manufacturing process 400 may include a quality check process for the initial wetting process, such as checking a weight of the prismatic battery cell 100 immediately after charging. For example, a second electrolyte charging operation in which an electrolyte is charged to achieve a desired weight may be applied to the battery cell. According to an embodiment, the battery cell manufacturing process 400 may include a pre-formation process of charging the prismatic battery cell 100 and discharging gas.

Referring to FIG. 4F, the electrolyte injection port may be sealed. For example, the electrolyte cap 138 may be inserted into the electrolyte injection port.

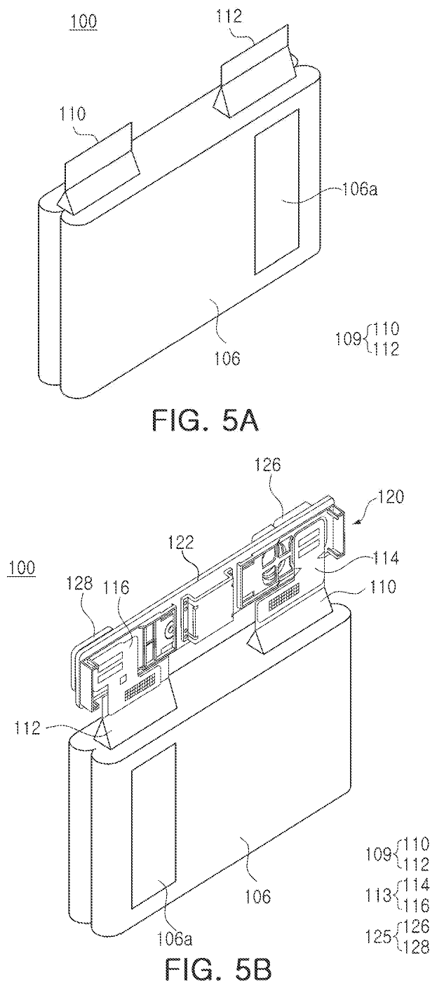

FIG. 5A is a perspective view of an electrode assembly 106 including an electrode foil 109, according to one embodiment. FIG. 5B is a perspective view illustrating a connection between an electrode foil 109 and an electrode terminal 125 on a top cap assembly 120, according to one embodiment.

Referring to FIGS. 5A and 5B, a battery cell 100 may include jelly roll 106 and/or top cap assembly 120. The jelly roll 106 may be an example of an electrode assembly. Hereinafter, in this document and claims, the electrode assembly will be described using a jelly roll as an example, and is denoted by the same reference numeral “106.”

FIG. 5A is a perspective view of an electrode assembly 106 including an electrode foil 109. The electrode foil 109 may include an anode foil 110 and a cathode foil 112. A sealing tape 106a, covering at least a portion of the electrode assembly 106, may be affixed to an outer surface of the electrode assembly 106.

FIG. 5B is a perspective view illustrating a connection between the electrode foil 109 and the electrode terminal 125 on a top cap assembly 120. The top cap assembly 120 may include a cap plate 122 and the electrode terminal 125. The electrode terminal 125 may include an anode terminal 126 and a cathode terminal 128. The electrode terminal 125 may be connected to the electrode foil 109. For example, the cathode foil 112 may be electrically connected to the cathode terminal 128, and the anode foil 110 may be electrically connected to the anode terminal 126. The electrode terminal 125 may be connected to the electrode foil 109 through a current collector 113. The current collector 113 may include an anode connector 114 and a cathode connector 116. The anode foil 110 may be connected to the anode terminal 126 (for example, the second anode terminal 126b in FIG. 2C) through the anode connector 114. The anode foil 110 and the anode connector 114 may be coupled to each other by welding (for example, ultrasonic welding or the like). The cathode foil 112 may be connected to the cathode terminal 128 (for example, the second cathode terminal 128b in FIG. 2C) through the cathode connector 116. The cathode foil 112 and the cathode connector 116 may be coupled to each other by welding (for example, ultrasonic welding or the like).

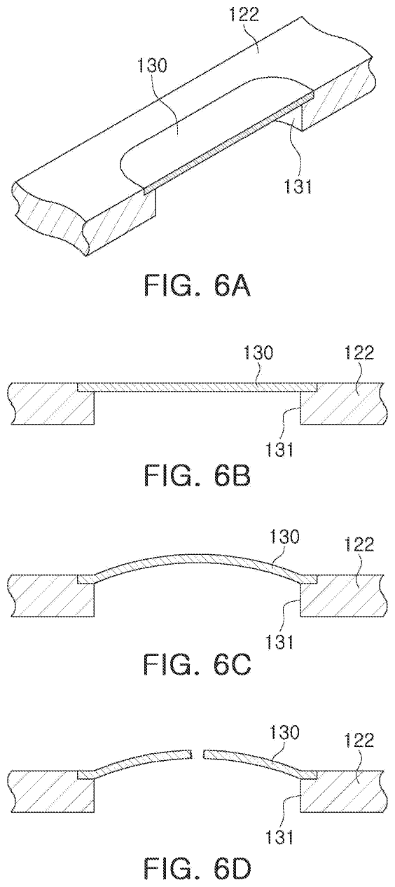

FIGS. 6A to 6D are views illustrating a vent cover according to an embodiment. FIG. 6A is a cross-sectional perspective views illustrating a portion of the vent cover illustrating in FIG. 2A. FIG. 6B is a cross-sectional view illustrating a state before a vent cover is deformed. FIG. 6C is a cross-sectional view illustrating a state in which the vent cover is expanded or inflated, and FIG. 6D is a state in which the vent cover is broken.

As illustrated in FIG. 6A, the vent cover 130 may be disposed on a cap plate 122. A venting hole 131 configured to discharge gas generated in the case 104 may be formed in the cap plate 122. The vent cover 130 may be disposed in the venting hole 131 to open the venting hole 131 when the pressure in the case 104 is equal to or higher than a set pressure. The vent cover 130 may have a material, shape, or structure bursting at a set pressure or higher. For example, the vent cover 130 may be formed of a thin and flexible material such as metal foil. The vent cover 130 may include a groove-shaped weakness part having a relatively small thickness so as to burst at a set pressure or higher.

The vent cover 130 may be disposed in the venting hole 131. In the cap plate 122, a step-shaped seating part may be formed around the venting hole 131, and the vent cover 130 may be disposed on the seating part. The vent cover 130 may have a slightly larger size than that of the venting hole 131 so as to cover the venting hole 131. The vent cover 130 may be formed of a thin breakable material which may be cut when a critical pressure is reached. The vent cover 130 may be fixed around the venting hole 131 by welding such as ultrasonic welding. Alternatively, the vent cover 130 may be fixed using an adhesive such as tape or glue designed to withstand a high pressure greater than the bursting pressure of the vent cover 130. That is, the tape or adhesive may have sufficient adhesive strength such that the vent cover 130 may not be separated from the venting hole 131 before the vent cover 130 bursts. In another embodiment, the cap plate 122 may be manufactured by coin stamping.

FIG. 6B illustrates a cross-section of the vent cover 130 disposed in the venting hole 131 while the battery cell 100 exhibits a normal internal pressure.

FIG. 6C illustrates a cross-section of the vent cover 130 disposed in the venting hole 131 while the battery cell 100 exhibits a higher internal pressure than in FIG. 6B. The vent cover 130 may bulge under increased internal cell pressure. That is, when the pressure in the case 104 increases, the vent cover 130 may swell toward the external side of the cap plate 122 or may have an expanded shape.

FIG. 6D illustrates a cross-section of the vent cover 130 disposed in the venting hole 131 at a higher internal pressure than FIG. 6C. The vent cover 130 may burst or may break or cut due to an increase in internal pressure.

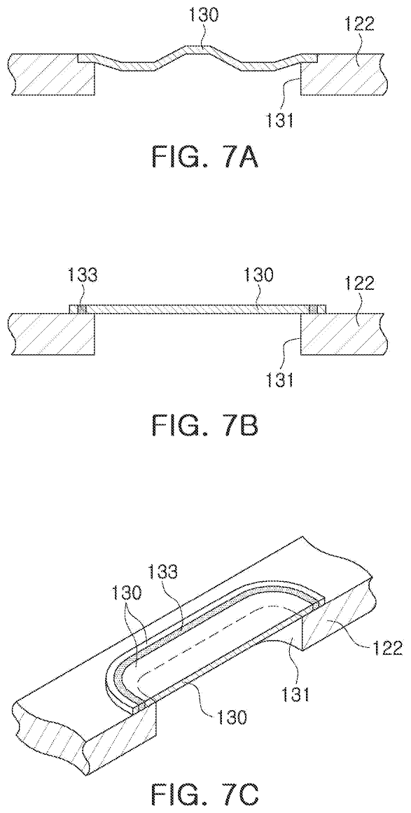

FIGS. 7A, 7B, and 7C are views illustrating a modified example of a vent cover. FIG. 7A is a cross-sectional view illustrating a first modified example of a vent cover, FIG. 7B is a cross-sectional view illustrating a second modified example of a vent cover, and FIG. 7C is a cross-sectional perspective view illustrating a portion of the vent cover illustrated in FIG. 7B.

As illustrated in FIG. 7a, the vent cover 130 may have a curved shape. The vent cover 130 having the curved shape may be disposed on a step-shaped seating part formed on the cap plate 122.

As illustrated in FIGS. 7B and 7C, the vent cover 130 may be attached to an upper surface of the cap plate 122 while covering the venting hole 131. The vent cover 130 may have a size larger than that of the venting hole 131 and may be fixed to the cap plate 122 by ultrasonic welding or the like. The vent cover 130 and the cap plate 122 may be welded along the welding line 133. Alternatively, the vent cover 130 and the cap plate 122 may be fixed using an adhesive such as tape or glue designed to withstand a high pressure greater than the bursting pressure of the vent cover 130.

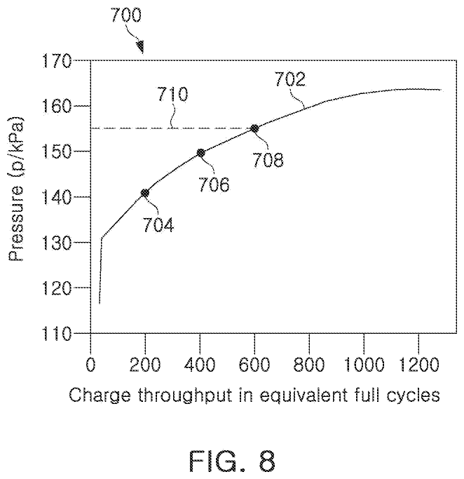

FIG. 8 illustrates the relationship between pressure and the number of charging cycles a battery cell 100 has gone through. In “Measurement of gas pressure in large-format prismatic lithium-ion cells during operation and cycle aging” by Schmitt et al., they investigate the impact of the state of charge (SOC), temperature, and aging on the gas pressure in of a prismatic battery cell 100. The gas pressure depends on the SOC in a non-linear way. This is caused by the dependence of the electrode volumes on the degree of lithiation. During long-term cycling, the pressure irreversibly increases, most likely due mainly to gas formation. The increase in pressure correlates with a loss of capacity, which basically qualifies internal gas pressure as an indicator of the state of health (SOH). The chart 700 illustrates the pressure in the battery cell 100 over several charge cycles. The line 702 illustrates the results of a test conducted in the cited study on the gas pressure in prismatic lithium-ion cells with a LiNi1/3Mn1/3Co1/3O2 cathode and a graphite anode. The battery cell 100 reaches a first internal pressure 704 after 200 cycles, a second internal pressure 706 after 400 cycles, and a third internal pressure 708 after 600 cycles. The dotted line 710 represents an example threshold that could be set for a pop-up pressure valve to be integrated into the battery cell 100. This threshold may be selected to maximize the longevity of the battery cell 100 while minimizing the risk of failure due to excessive pressure. The threshold may be related to the bursting threshold of a bursting vent cover 130. It may coincide with the bursting vent cover 130 threshold to inform an observer that the bursting vent cover 130 has burst. It could be set to a lower pressure to signal a user that the battery cell 100 is nearing the internal pressure threshold for the bursting vent cover 130.

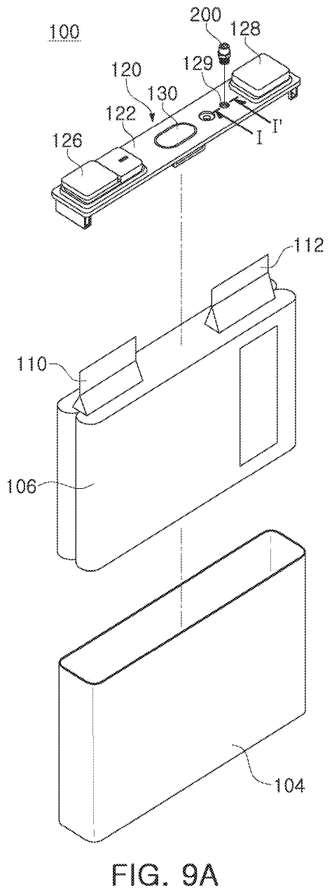

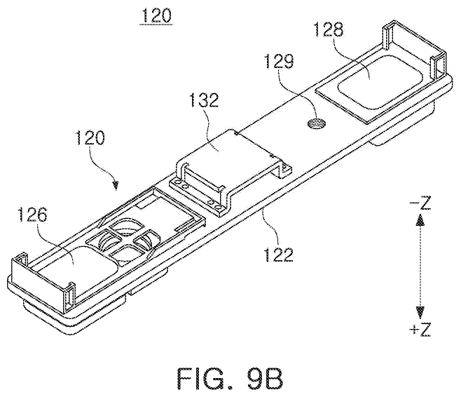

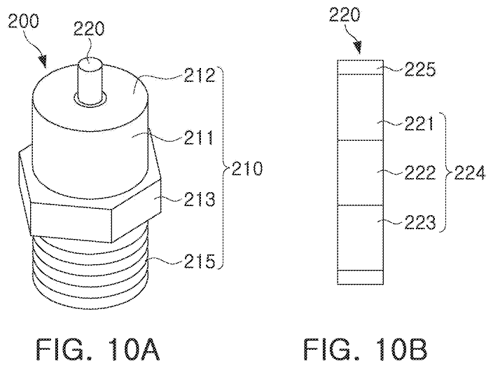

FIG. 9A is an exploded perspective view illustrating a battery cell according to an embodiment, FIG. 9B is a perspective view illustrating a top cap assembly illustrated in FIG. 9A viewed from the bottom.

Referring to FIG. 9A, a battery cell 100 may include a case 104, a cap plate 122 and a pop-up pressure indicator 200.

The case 104 may accommodate the electrode assembly 106, and the cap plate 122 may cover the case 104. The electrode assembly 106 may be accommodated in a space defined by the case 104 and the cap plate 122. The electrode assembly 106 may include an anode foil 110 and a cathode foil 112.

The cap plate 122 may be provided to the top cap assembly 120. The top cap assembly 120 may include a cap plate 122, an anode terminal 126, a cathode terminal 128, and a vent cover 130. The anode terminal 126 may be disposed on the cap plate 122 and may be electrically connected to the anode foil 110. The cathode terminal 128 may be disposed on the cap plate 122 and may be electrically connected to the cathode foil 112. The vent cover 130 may be disposed on the cap plate 122 and may be opened when the pressure in the case 104 rises above a threshold value, such that gas in the case 104 may be discharged.

Referring to FIG. 9B, the vent guard 132 may protect the vent cover 130 to prevent malfunction of the vent cover 130. The vent guard 132 may be disposed in a position opposing the vent cover 130. The vent guard 132 may be attached to a lower surface of the cap plate 122.

The pop-up pressure indicator 200 may be installed on the cap plate 122 or the case 104 to check the increase in pressure in the case 104. When the pop-up pressure indicator 200 is disposed on the cap plate 122, the cap plate 122 may include a coupling hole 129 communicating with the internal space of the case 104. The coupling hole 129 may penetrate through the cap plate 122 as illustrated in FIGS. 9A and 9B. A pop-up pressure indicator 200 may be fixed to the coupling hole 129. The pop-up pressure indicator 200 may communicate with the internal portion of the case 104 while being inserted into the coupling hole 129. By forming the coupling hole 129 in the cap plate 122, the pop-up pressure indicator 200 may be installed on the cap plate 122 without damaging integrity of the top cap assembly 120.

FIG. 10A is a perspective view illustrating the pop-up pressure indicator illustrated in FIG. 9A. FIG. 10B is a view illustrating the pop-up indicator illustrated in FIG. 10A.

Referring to FIG. 10A, the pop-up pressure indicator 200 may include a housing 210 forming an exterior and a pop-up indicator 220. As illustrated in FIG. 10A, the pop-up pressure indicator 200 may be provided as a screw-in pop-up valve. The screw-in pop-up valve may be screwed into the cap plate 122 or the case 104. Alternatively, the pop-up pressure indicator 200 may be welded and coupled to the cap plate 122 or the case 104.

The housing 210 may be coupled to the coupling hole 129 of the cap plate 122 and may accommodate at least a portion of the pop-up indicator 220. The housing 210 may include a body 211 accommodating the pop-up indicator 220 and a screw 215 screwed to the cap plate 122. The housing 210 may include a collar 213 disposed between the body 211 and the screw 215. The collar 123 may have a cross-sectional area larger than that of the body 211 such that the housing 210 may be supported on the cap plate 122 when the housing 210 is installed on the cap plate 122. The collar 213 may have a polygonal structure such as a hexagon such that a fastening tool may be coupled thereto. Accordingly, the screw 215 may be easily screwed into the coupling hole 129 by rotating the fastening tool coupled to the collar 213. The housing 210 may be screwed into the coupling hole 129 formed in the cap plate 122 or the case 104 through a screw 215.

The pop-up indicator 220 may penetrate through the housing 210 and be exposed externally. For example, at least a portion of the pop-up indicator 220, for example, an upper end, may be exposed to the external side of the housing 210 through the top surface 212 of the body 211. The pop-up indicator 220 may protrude outwardly when pressure in the case 104 increases. The pop-up indicator 220 may be configured such that a length protruding out of the housing 210 may be changed depending on changes in pressure in the case 104. For example, the pop-up indicator 220 may have a longer protruding length when the internal pressure of the case 104 is increased.

Referring to FIG. 10B, the pop-up indicator 220 may be partitioned into a plurality of regions 221, 222, and 223 depending on a length protruding out of the housing 210. The plurality of regions 221, 222, and 223 may form a pressure indicating region 224 indicating pressure in the case 104. For example, the pressure indicating region 224 may be partitioned into the first region 221, the second region 222, and the third region 223 from a position close to the top surface 212 of housing 210. The first region 221 may be visualized by being exposed externally of the housing 210 in a state in which the internal pressure of the case is the first pressure. The second region 222 may be visualized by being exposed externally of the housing 210 in a state in which the internal pressure of the case is the second pressure greater than the first pressure. The third region 223 may be visualized by being exposed externally of the housing 210 in a state in which the internal pressure of the case is a third pressure greater than the second pressure. In a normal state, the exposed region 225 of the pop-up indicator 220 may be exposed externally of the housing 210, but the pressure indicating region 224 is not exposed externally.

The plurality of regions 221, 222, and 223 may be configured to be visually distinct such that a user or an observer may easily check the pressure state in the case. For example, the plurality of regions 221, 222, and 223 may display the pressure state in the case through visual means such as colors, letters, numbers, and symbols. The plurality of regions 221, 222, and 223 may be configured to be visualized when the pressure in the case corresponds to a preset value. For example, the third pressure for visualizing the third region 223 may indicate a bursting threshold value of the vent cover 130 or a pressure immediately before bursting.

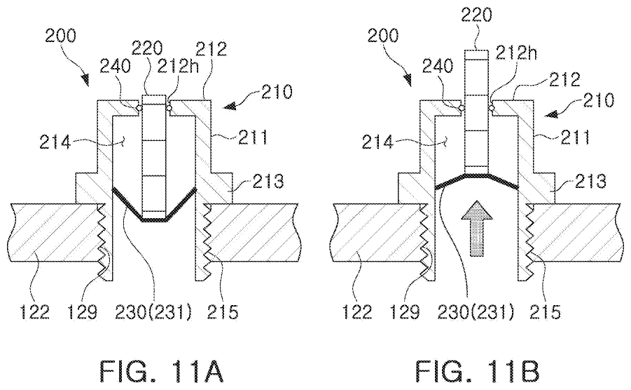

FIGS. 11A and 11B are cross-sectional views taken along line I-I′ in FIG. 9A. FIG. 11A illustrates a normal state, and FIG. 11B illustrates a state in which internal pressure rises.

Referring to FIG. 11A, a pop-up pressure indicator 200 may be installed on a cap plate 122. The housing 210 may be fixed to the coupling hole 129 on an external side of the cap plate 122. A screw 215 of the housing 210 may be screwed into the coupling hole 129 of the cap plate 122. To this end, a screw thread corresponding to the screw 215 may be formed in the coupling hole 129. Since the coupling hole 129 has a shape penetrating through the cap plate 122, the pop-up pressure indicator 200 may communicate with the internal space of the case 104 through the coupling hole 129. With the housing 210 coupled to the cap plate 122, the collar 213 may be seated on the cap plate 122.

In the normal state, the exposed region 225 disposed on one side (upper side) of the pop-up indicator 220 may be exposed toward the external side of the top surface 212 through the through-hole 212h, and a pressure indicating region 224 disposed on the other side (lower side) of the pop-up indicator 220 may be disposed in the installation space 214 of the housing 210.

The pop-up pressure indicator 200 may further include a pressure transmission part 230 for transmitting pressure in the case 104 to the pop-up indicator 220. The pressure transmission part 230 may be coupled to the pop-up indicator 220 and may be disposed to intersect the installation space 214 of the housing 210. Accordingly, the pressure transmission part 230 may partition the installation space 214 of the housing 210 and the internal space of the case 104. As an example, the pressure transmission part 230 may include a deformation part 231 deformed depending on changes in pressure in the case 104 and moving the pop-up indicator 220. The deformation part 231 may have a thin film shape and may be formed of a flexible material. The deformation part 231 may include an elastically deformable material such that the deformation part 231 may return to an original position thereof when the pressure is reduced. The deformation part 231 may be fixed to each of the housing 210 and the pop-up indicator 220. For example, a central portion of the deformation part 231 may be fixed to the pop-up indicator 220, and a circumference of the deformation part 231 may be fixed to the internal side wall surface of the body 231. The circumference of the deformation part 231 may have a fixed position on an internal side wall surface of the body 231. A lower side of the deformation part 231 may oppose the internal space of the case 104, and an upper side of the deformation part 231 may oppose the installation space 214 of the housing 210. When the internal pressure of the case 104 is in a normal state, the pop-up indicator 220 may hardly protrude from the top surface 212 of the housing 210. An external side sealing member 240 may be disposed between the pop-up indicator 220 and the through-hole 212h to block the installation space 214 from an external region. Alternatively, the external side sealing member 240 may not be disposed in the through-hole 212h.

Referring to FIG. 11B, when the internal pressure of case 104 increases, the deformation part 231 may be deformed in an upward direction. Accordingly, the pop-up indicator 220 fixed to the deformation part 231 may move in an upward direction (arrow direction). When the pressure in the case 104 increases, the deformation part 231 may be deformed further in the upward direction, and the length of the pop-up indicator 220 protruding out of the housing 210 may also increase. The length at which the pop-up indicator 220 protrudes may be designed to be adjusted according to the pressure in the case. The amount of protrusion of the pop-up indicator 220 may be adjusted by elasticity of the deformation part 231, the length of the pop-up indicator 220, and the like.

A user or an observer may sense or monitor the internal pressure of the battery cell 100 based on the outward protrusion of the pop-up indicator 220. For example, a user or an observer may visually check the protruding length or degree of the pop-up indicator 220 and may check whether the pressure in the battery cell 100 is stable or not based on the protruding length or degree. Also, as described with reference to FIG. 8, when the number of times the charging cycle is performed generally increases, the pressure of the battery cell 100 may tend to increase. Accordingly, in the process of testing or inspecting the battery cell 100, a lifespan or stability of the battery cell may be visually and easily checked based on the protruding length of the pop-up indicator 220. Since the pressure of the battery cell 100 may be checked without a measuring device, costs consumed in a test process and/or inspection process of the battery cell 100 may be reduced.

Meanwhile, the pressure transmission part 230 may be configured to be broken when the pressure in the case is at a set pressure or higher. In this case, the gas in the case 104 may be discharged externally of the housing 210 through the housing 210 due to the broken pressure transmission part 230. For example, the deformation part 231 may be configured to burst or break when the internal pressure of the case 104 is greater than a threshold value. When the deformation part 231 bursts or is broken, the deformation part 231 may assist the vent cover 130 to discharge gas together with the vent cover 130, thereby increasing gas discharge. Alternatively, when the deformation part 231 bursts or is broken above the threshold value, the deformation part 231 may replace the function of the vent cover 130, and in this case, the vent cover 130 may not be installed.

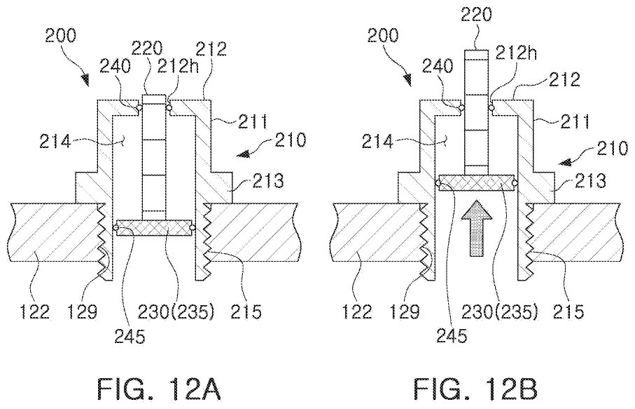

FIGS. 12A and 12B are cross-sectional views illustrating a modified example in FIGS. 11A and 11B. FIG. 12A illustrates a normal state, and FIG. 12B illustrates a state in which internal pressure rises.

As compared to the pop-up pressure indicator 200 illustrated in FIGS. 11A and 11B, the pop-up pressure indicator 200 illustrated in FIGS. 12A and 12B may be different in terms of the configuration of the pressure transmission part 230.

The pressure transmission part 230 may include a moveable part 235 moving in the housing 210 depending on changes in pressure in the case 104. The moveable part 235 may be configured to slide in the housing 210. The moveable part 235 may have a plate shape and may include a material having rigidity such as synthetic resin or metal. A central portion of the moveable part 235 may be fixed to the pop-up indicator 220, and a circumference of the moveable part 235 may slide along an internal wall surface of the body 211. An internal-side sealing member 245 for sealing may be disposed between the circumference of the moveable part 235 and the internal wall surface of the body 211.

As illustrated in FIG. 12A, when the internal pressure of the case 104 is in a normal state, the pop-up indicator 220 may hardly protrude from the top surface 212 of the housing 210.

Referring to FIG. 12B, when the internal pressure of case 104 increases, the moveable part 235 may move in an upward direction. Accordingly, the pop-up indicator 220 fixed to the moveable part 235 may move in an upward direction (arrow direction). When the pressure in the case 104 increases, the moveable part 235 may move further in the upward direction, and the length of the pop-up indicator 220 protruding out of the housing 210 may also increase. The length at which the pop-up indicator 220 protrudes may be designed to be adjusted according to the pressure in the case. The amount of protrusion of the pop-up indicator 220 may be adjusted by frictional force between the moveable part 235 and the internal wall surface (or the internal-side sealing member).

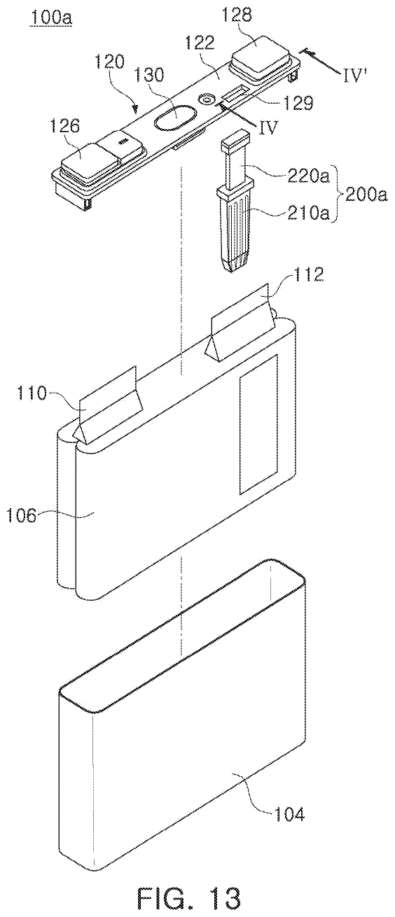

FIG. 13 is an exploded perspective view illustrating a battery cell according to another embodiment.

The battery cell 100a illustrated in FIG. 13 may include a case 104, a cap plate 122 and a pop-up pressure indicator 200a. The battery cell 100a illustrated in FIG. 13 is different from the battery cell 100 illustrated in FIG. 9A only in terms of the configuration of the pop-up pressure indicator 200a.

The pop-up pressure indicator 200a may be provided as a welded pop-up valve. The welded pop-up valve may be welded and coupled to the cap plate 122 or the case 104.

The pop-up pressure indicator 200a may include a housing 210a and a pop-up indicator 220a. The housing 210a may be welded to the coupling hole 129. The pop-up pressure indicator 200a may be disposed on a lower side of the cap plate 122 and may be disposed in the internal space of the case 104. A pop-up pressure indicator 200a may be disposed between the electrode assembly 106 and the case 104. For example, the pop-up pressure indicator 200a may be disposed between a relatively wide side of the electrode assembly 106 and a relatively wide side of the case 104. In this case, a width of a portion of the housing 210a opposing a relatively wide side of the case 104 may have a greater value than the thickness of a portion disposed between the case 104 and the electrode assembly 106. Accordingly, the volume of the space in which the pop-up pressure indicator 200a is installed may be reduced.

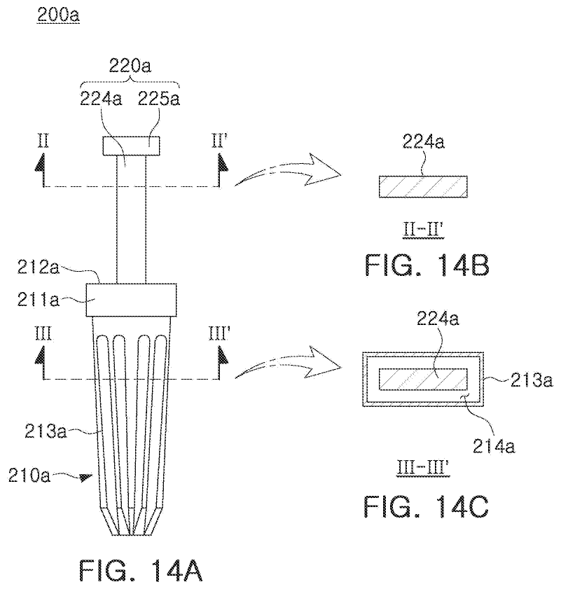

FIG. 14A is a view illustrating the pop-up pressure indicator illustrated in FIG. 13, viewed from the front. FIG. 14B is a cross-sectional view taken along line II-II′ in FIG. 14A. FIG. 14C is a cross-sectional view taken along line III-III′ in FIG. 14A.

Referring to FIG. 14A, the pop-up pressure indicator 200a may include a housing 210a and a pop-up indicator 220a. The housing 210a may include a first body 211a fixed to the coupling hole 129 formed in the cap plate 122 and a second body 213a disposed between the case 104 and the electrode assembly 106. The second body 213a may be disposed between a relatively wide side of the case 104 and a relatively wide side of the electrode assembly 106. The pop-up indicator 220a may be exposed externally of the housing 210a through the upper surface 212a of the first body 211a. The pop-up indicator 220a may include a pressure indicating region 224a and an exposed region 225a. The pressure indicating region 224a may have the configuration the same as or similar to that of the pressure indicating region 224 described with reference to FIG. 10B. For example, the pressure indicating region 224a may be partitioned into a plurality of regions.

Referring to FIGS. 14B and 14C, the second body 213a, the pressure indicating region 224a and the installation space 214a of the housing 210a may have a cross-section in which one side has a width narrower than that of the other side. By forming the cross-section of the pop-up pressure indicator 200a to have a flat profile as described above, the volume of the space in which the pop-up pressure indicator 200a is installed may be reduced.

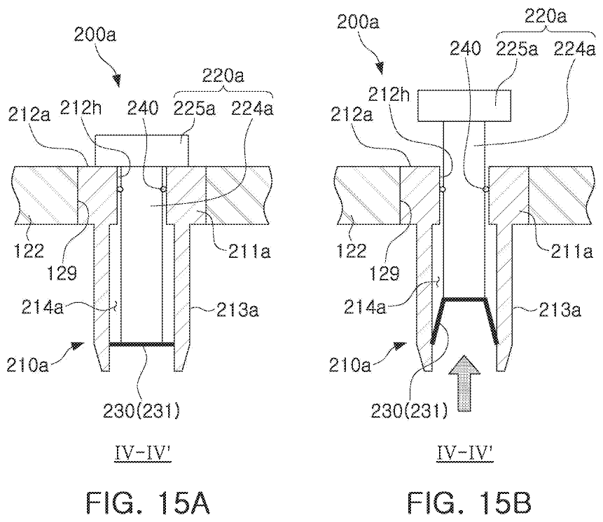

FIGS. 15A and 15B are cross-sectional views taken along line IV-IV′ in FIG. 13. FIG. 15A illustrates a normal state, and FIG. 15B illustrates a state in which internal pressure rises.

Referring to FIG. 15A, the pop-up pressure indicator 200a may be welded and coupled to the cap plate 122. For example, the first body 211a of the housing 210a may be welded to the cap plate 122 while being inserted into the coupling hole 129. The second body 213a of the housing 210a may be disposed below the cap plate 122. Since the coupling hole 129 has a shape penetrating through the cap plate 122, the pop-up pressure indicator 200a may communicate with the internal space of the case 104 through the coupling hole 129.

In the normal state, the exposed region 225a disposed on one side (upper side) of the pop-up indicator 220a may be exposed in a direction of an external side of a top surface 212a through the through-hole 212h, and the pressure indicating region 224a disposed on the other side (lower side) of the pop-up indicator 220a may be disposed in the installation space 214a of the housing 210a.

The pop-up pressure indicator 200a may further include a pressure transmission part 230 for transmitting the pressure in the case 104 to the pop-up indicator 220a. The pressure transmission part 230 may include the deformation part 231 described in FIGS. 11A and 11B. The pressure transmission part 230 may also include the moveable part 235 described in FIGS. 12A and 12B.

Referring to FIG. 15B, when the internal pressure of case 104 increases, the deformation part 231 may be deformed in an upward direction. Accordingly, the pop-up indicator 220a fixed to the deformation part 231 may move in an upward direction (arrow direction). When the pressure in the case 104 increases, the deformation part 231 may be deformed further in the upward direction, and the length of the pop-up indicator 220a protruding out of the housing 210a may also increase. A user or an observer may sense or monitor the internal pressure of the battery cell 100 the protrusion of the pop-up indicator 220a.

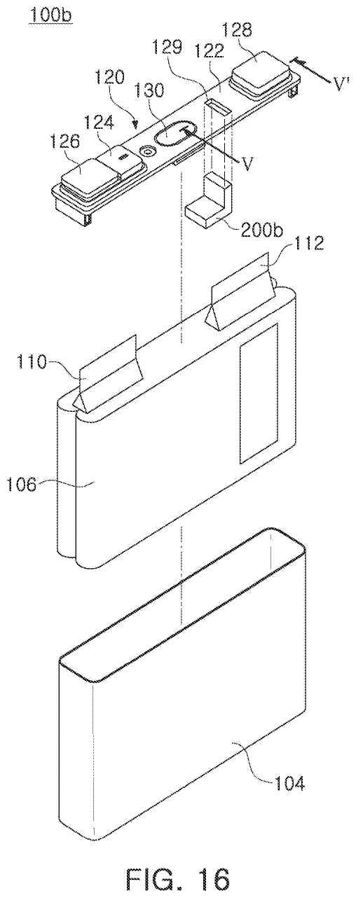

FIG. 16 is an exploded perspective view illustrating a battery cell according to another embodiment.

The battery cell 100b illustrated in FIG. 16 may include a case 104, a cap plate 122 and a pop-up pressure indicator 200b. The battery cell 100b illustrated in FIG. 16 may be different from the battery cell 100 illustrated in FIG. 9A only in terms of the configuration of the pop-up pressure indicator 200b.

The pop-up pressure indicator 200b may be provided as a lateral pop-up valve. The lateral pop-up valve may be welded and coupled to the cap plate 122 or the case 104. For example, the pop-up pressure indicator 200b may be welded to the coupling hole 129.

The pop-up pressure indicator 200b may be disposed on the lower side of the cap plate 122 and may be disposed in an internal space of the case 104. A pop-up pressure indicator 200b may be disposed between the cap plate 122 and the electrode assembly 106. For example, the pop-up pressure indicator 200b may be disposed between the lower surface of the cap plate 122 and the upper surface of the electrode assembly 106. When the anode foil 126 and the cathode foil 128 are disposed on the upper surface of the electrode assembly 106, the pop-up pressure indicator 200b may be disposed in a free space between the anode foil 126 and the cathode foil 128. In this case, the volume of the space for installing the pop-up pressure indicator 200b may be reduced.

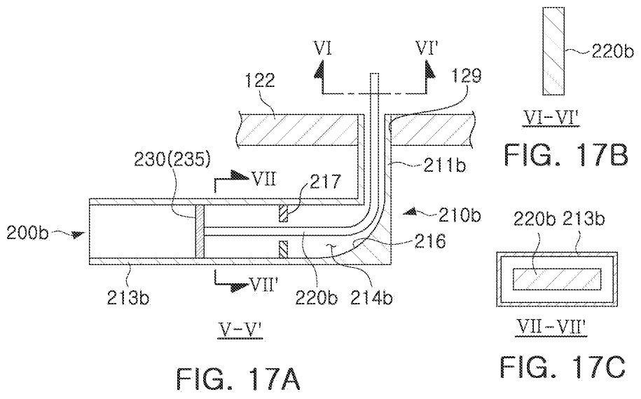

FIG. 17A is a cross-sectional view taken along line V-V′ in FIG. 16. FIG. 17B is a cross-sectional view taken along line VI-VI′ in FIG. 17A. FIG. 17C is a cross-sectional view taken along line VII-VII′ in FIG. 17A.

Referring to FIG. 17A, the pop-up pressure indicator 200b may include a housing 210b and a pop-up indicator 220b. The housing 210b may include a first body 211b fixed to the coupling hole 129 formed in the cap plate 122 and a second body 213b disposed between the cap plate 122 and the electrode assembly 106. The first body 211b of the pop-up pressure indicator 200b may be welded and coupled to the cap plate 122. The second body 213b may be connected to the first body 211b and may be inclined with respect to the first body 211b. For example, the second body 213b may be extended at an angle of 90 degrees with respect to the first body 211b.

The pop-up indicator 220b may be disposed in the installation space 214b formed in the first body 211b and the second body 213b. One side (an upper side) of the pop-up indicator 220b may be exposed externally of the housing 210b. The pop-up indicator 220b may include a pressure indicating region (224 in FIG. 10B), and the pressure indicating region may be partitioned into a plurality of regions. Since the pop-up indicator 220b is formed across the first body 211b and the second body 213b, the pop-up indicator 220b may have a bent shape.

The pop-up pressure indicator 200b may include a pressure transmission part 230 for transmitting pressure in the case 104 to the pop-up indicator 220b. The pressure transmission part 230 may include the moveable part 235 described in FIGS. 12A and 12B. Alternatively, the pressure transmission part 230 may include the deformation part 231 described in FIGS. 11A and 11B. The housing 210b may include a stopper 217 limiting movement of the pressure transmission part 230. As the movement of the pressure transmission part 230 is limited, the length at which the pop-up indicator 220b is exposed externally may also be limited. That is, the maximum amount of the pop-up indicator 220b may be determined depending on a position of the stopper 217.

The pop-up indicator 220b may have a bent shape corresponding to the shapes of the first body 211b and the second body 213b. The pop-up indicator 220b may include a bendable material such that the pop-up indicator 220b may move smoothly in the installation space 214b. The pop-up indicator 220b may include a flexible and elastic material.

The first body 211b and the second body 213b of the housing 210b may be connected to each other by a guide surface 216 including a curved surface. Since the pop-up indicator 220b is guided by the guide surface 216 during movement, the pop-up indicator 220b may easily move in the installation space 214b. The pop-up indicator 220b may smoothly move through the guide surface 216 between an inner space of the first body 211b and an inner space of the second body 213b.

When the internal pressure of case 104 increases, the pressure transmission part 230 may move in a horizontal direction. Accordingly, one side of the pop-up indicator 220b, connected to the pressure transmission part 230, may move in a horizontal direction, and the other side adjacent to the coupling hole 129 may move in a vertical direction. As the pressure in the case 104 increases, the length by which the pop-up indicator 220b protrudes externally may increase. A user or an observer may sense or monitor the internal pressure of the battery cell 100 based on the outward protrusion of pop-up indicator 220b. When the pressure in the case 104 further increases, the movement of the pressure transmission part 230 may be limited by the stopper 217, such that the protruding amount of the pop-up indicator 220b may also be limited.

Referring to FIGS. 17B and 17C, the second body 213b of the housing 210b and the pop-up indicator 220b may have a cross-section in which a width of one side thereof is narrower than a width of the other side. By forming one surface of the cross-section of the pop-up pressure indicator 200b to have a flat profile as described above, the volume of the space in which the pop-up pressure indicator 200b is installed may be reduced.

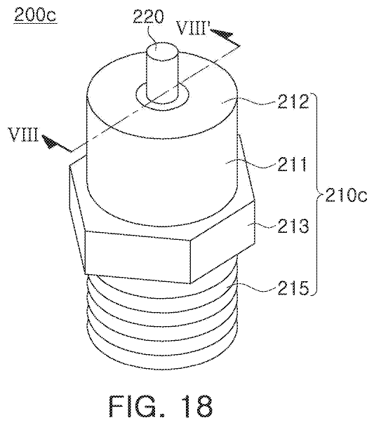

FIG. 18 is a perspective view illustrating a pop-up pressure indicator 200c according to an embodiment.

The pop-up pressure indicator 200c may include a housing 210c and a pop-up indicator 220. The housing 210c may have a shape similar to that of the housing 210 described with reference to FIG. 10A. For example, the housing 210c may include a body 211, a collar 213 and a screw 213. The pop-up indicator 220 may have a configuration the same as or similar to that of the pop-up indicator 210 described with reference to FIG. 10A.

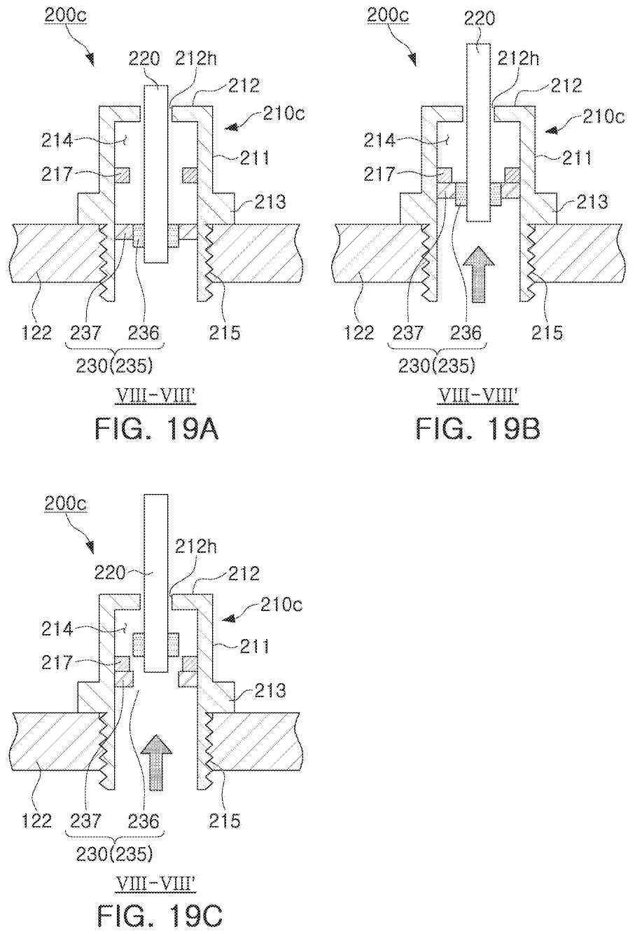

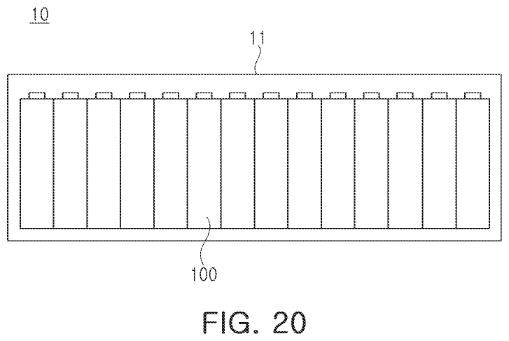

FIGS. 19A to 19C are cross-sectional views taken along line VIII-VIII′ in FIG. 18. FIG. 19A illustrates a normal state, and FIG. 19B illustrates a state in which internal pressure further rises than in FIG. 19A. FIG. 19C is a state in which internal pressure further rises than in FIG. 19B.

Referring to FIG. 19A, a housing 210c of the pop-up pressure indicator 200c may include a stopper 217 on an internal wall surface of a body 211. The stopper 217 may limit the movement of the pressure transmission part 230.

The pressure transmission part 230 may be fixed to the pop-up indicator 220 and may slide along an internal space of the body 211. The pressure transmission part 230 may include a moveable part 235 moving in the housing 210c depending on changes in pressure in the case 104. The moveable part 235 may include a burstable slide part 236 and a non-burstable slide part 237. The pop-up indicator 220 may be fixed to one of the burstable slide part 236 and the non-burstable slide part 237.

FIG. 19B illustrates the example in which the internal pressure of the battery cell increases. When the internal pressure of the case 104 increases, the pressure transmission part 230 may move in an upward direction. Accordingly, the pop-up indicator 220 fixed to the pressure transmission part 230 may move in an upward direction (arrow direction). When the pressure in the case 104 increases, the pressure transmission part 230 may be in contact with the stopper 217 and the movement of the pressure transmission part 230 and the pop-up indicator 220 may be limited. A user or observer may sense or monitor the internal pressure of the battery cell 100 based on the outward protrusion of the pop-up indicator 220.

FIG. 19C illustrates the example in which the internal pressure of the battery cell increases further than that in FIG. 19B. In this case, the burstable slide part 236 and the non-burstable slide part 237 may be separated from each other by the internal pressure of case 104. Accordingly, the gas in the case 104 may be discharged through the through-hole 212h. When the pressure transmission part 230 bursts or is broken, the pressure transmission part 230 may assist the vent cover 130 and may discharge gas together with the vent cover 130, thereby increasing the amount of gas discharge. When the pressure transmission part 230 has a bursting or broken component, since the pressure transmission part 230 may replace the function of the vent cover 130, the vent cover 130 may not be installed.

FIG. 20 is a view illustrating a battery device according to an embodiment.

Referring to FIG. 20, a battery device 10 may include a plurality of battery cells 100 and a device housing 11 accommodating the plurality of battery cells.

The plurality of battery cells 100 may include battery cells including the pop-up pressure indicators 200, 200a, 200b, and 200c described with reference to FIGS. 9 to 19. The pop-up pressure indicators 200, 200a, 200b, and 200c may include pop-up indicators 220, 220a, and 220b protruding outwardly when the pressure in the case 104 increases.

The battery device 10 may open the device housing 11 for repair, inspection and/or reuse. When the pressure of the battery cell 100 increases, the pop-up indicators 220, 220a, and 220b may protrude externally. A user, an observer, and/or an operator may sense or monitor the internal pressure of the battery cell 100 based on the outward protrusion of the pop-up indicators 220, 220a, and 220b. For example, a user, observer, and/or operator may visually check the protruding length or degree of the pop-up indicators 220, 220a, and 220b, and may check whether the pressure in the battery cell 100 is stable based on the observation or not. Also, a user, observer, and/or operator may easily distinguish the battery cell 100 having a higher internal pressure than a set value through the pop-up indicators 220, 220a, and 220b.

Also, as described with reference to FIG. 8, generally, when the number of times the charging cycle is performed increases, the pressure of the battery cell 100 may tend to increase. Accordingly, based on the protruding lengths of the pop-up indicators 220, 220a, and 220b, a lifespan or stability of the battery cell may be visually and easily checked.

Since the pressure of the battery cell 100 may be checked without a separate measuring device, costs consumed in a test process and/or inspection process of the battery cell 100 may be reduced

Functions performed in a process and method may be implemented in a different order. In addition, outlined steps and operations may be only provided as examples, and some of the steps and operations may be optional, combined into fewer steps and operations, or expanded into additional steps and operations without detracting from the essence of the disclosed embodiments.

Only specific examples of implementations of certain embodiments are described. Variations, improvements and enhancements of the disclosed embodiments and other embodiments may be made based on the disclosure of this patent document.

In addition, the embodiment has been described using a prismatic battery cell as an example, but the embodiment may be applied to a cylindrical battery cell or a coin-type battery cell.

### DESCRIPTION OF REFERENCE CHARACTERS

100, 100A, 100B . . . BATTERY CELL
104 . . . CASE
106 . . . ELECTRODE ASSEMBLY
122 . . . CAP PLATE
129 . . . COUPLING HOLE
130 . . . VENT COVER
200, 200A, 200B, 200C . . . POP-UP PRESSURE INDICATOR
210, 210A, 210B, 210C . . . HOUSING
220, 220A, 220B . . . POP-UP INDICATOR
230 . . . PRESSURE TRANSMISSION PART
231 . . . DEFORMATION PART
235 . . . MOVEABLE PART (MOVABLE PART)
236 . . . BURSTABLE SLIDE PART (BURSTABLE SLIDE PART)
237 . . . NON-BURSTABLE SLIDE PART

What is claimed is:

1. A battery cell, comprising:
a case configured to accommodate an electrode assembly;
a cap plate covering the case; and
a pop-up pressure indicator including a pop-up indicator configured to protrude outwardly when pressure in the case increases.

2. The battery cell of claim 1,
wherein the pop-up pressure indicator further includes a housing accommodating at least a portion of the pop-up indicator, and
wherein the pop-up indicator penetrates through the housing and is exposed externally.

3. The battery cell of claim 2, wherein the pop-up indicator is configured such that a length protruding externally of the housing is changed depending on changes in pressure in the case.

4. The battery cell of claim 2, wherein the pop-up indicator is partitioned into a plurality of regions depending on a length protruding externally of the housing.

5. The battery cell of claim 4, wherein the plurality of regions is configured to be visually distinct.

6. The battery cell of claim 2, wherein the housing is fixed to the cap plate or the case.

7. The battery cell of claim 2,
wherein the cap plate includes a coupling hole communicating with an internal space of the case, and
wherein the housing is installed in the coupling hole.

8. The battery cell of claim 7, wherein the housing is fixed to the coupling hole on an external side of the cap plate.

9. The battery cell of claim 7, wherein the housing includes a first body fixed to the coupling hole and a second body disposed between the case and the electrode assembly.

10. The battery cell of claim 9, wherein a width of a portion of the housing opposing the case has a value greater than a thickness of a portion of the housing disposed between the case and the electrode assembly.

11. The battery cell of claim 7,
wherein a first side of the housing is fixed to the coupling hole, and
wherein a second side of the housing is disposed between the cap plate and the electrode assembly.

12. The battery cell of claim 11,
wherein the housing includes a first body fixed to the coupling hole and a second body connected to the first body and inclined with respect to the first body, and
wherein the second body is disposed between the cap plate and the electrode assembly.

13. The battery cell of claim 12,
wherein the first body and the second body are connected to each other by a guide surface including a curved surface, and
wherein the pop-up indicator includes a bendable material to smoothly move through the guide surface between an inner space of the first body and an inner space of the second body.

14. The battery cell of claim 2, wherein the pop-up pressure indicator further includes a pressure transmission part coupled to the pop-up indicator and transmitting pressure in the case to the pop-up indicator.

15. The battery cell of claim 14,
wherein the pressure transmission part includes a deformation part configured to deform depending on changes in pressure in the case and configured to move the pop-up indicator, and
wherein the deformation part is fixed to each of the housing and the pop-up indicator.

16. The battery cell of claim 14,
wherein the pressure transmission part includes a moveable part fixed to the pop-up indicator and configured to move in the housing depending on changes in pressure in the case, and
wherein the moveable part is configured to slide in the housing.

17. The battery cell of claim 14, wherein the housing further includes a stopper configured for limiting movement of the pressure transmission part.

18. The battery cell of claim 17, wherein the pressure transmission part includes a burstable slide part configured to be broken when in contact with the stopper.

19. The battery cell of claim 14,
wherein the pressure transmission part is configured to be broken when pressure in the case at a set pressure or higher, and
wherein gas in the case is discharged externally through the housing by the breakage of the pressure transmission part.

20. A battery device, comprising:
a plurality of battery cells; and
a device housing configured to accommodate the plurality of battery cells,
wherein at least one battery cell of the plurality of battery cells includes a case configured to accommodate an electrode assembly, a cap plate covering the case, and a pop-up indicator protruding outwardly when pressure in the case increases.
